(19) United States
(12) Patent Application Publication
(10) Pub. No.: US 2026/0128994 A1
(43) Pub. Date: May 7, 2026

(54) DYNAMIC QOS PROFILES SIGNALING

(71) Applicant: Cisco Technology, Inc., San Jose, CA (US)

(72) Inventors: Binita GUPTA, San Diego, CA (US); Malcolm M. SMITH, Richardson, TX (US); Brian D. HART, Sunnyvale, CA (US)

(21) Appl. No.: 19/379,715

(22) Filed: Nov. 4, 2025

Related U.S. Application Data
(60) Provisional application No. 63/716,665, filed on Nov. 5, 2024.
(60) Provisional application No. 63/796,172, filed on Apr. 28, 2025.

(51) Int. Cl. H04L 47/24; H04L 5/00

(52) U.S. Cl. CPC H04L 47/24; H04L 5/0044

(57) ABSTRACT

A wireless device comprises one or more memories and one or more processors communicatively coupled to the one or more memories, where the one or more processors are configured to, individually or collectively, perform operations comprising identifying a flow associated with a stream classification service (SCS) identifier and transmitting an SCS request to an access point (AP). The SCS request comprises information for a plurality of quality of service (QoS) profiles associated with the SCS identifier, and each of the plurality of QoS profiles define a different set of QoS characteristics.

### CROSS-REFERENCE TO RELATED APPLICATIONS

This application claims benefit of U.S. provisional patent application Ser. No. 63/716,665 filed Nov. 5, 2024, and. U.S. provisional patent application Ser. No. 63/796,172 filed Apr. 28, 2025. The aforementioned related patent applications are herein incorporated by reference in their entirety.

### TECHNICAL FIELD

Embodiments presented in this disclosure generally relate to computer networking. More specifically, embodiments disclosed herein describe dynamic quality of service (QoS) profiles signaling details.

### BACKGROUND

IEEE 802.11be added support for Stream Classification Service (SCS) with a quality-of-service characteristics element (QoS Char) to provide traffic characteristics for SCS flows to the access point (AP) for uplink (UL) and downlink (DL). This enables the AP to perform more efficient scheduling of resources to a station (STA) for the UL and DL, because it is made aware of each stream's QoS needs.

However, if the STA is not triggered frequently enough by the AP, the STA may disable UL multi-user (MU) data, rather than waiting for additional UL triggers. Dropping out of MU mode by the STA may undesirably hurt network efficiency. For example, reverting to contention-based enhanced distributed channel access (EDCA) reduces MU coordination and nullifies the advantages of intelligent scheduling by the AP.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates a system for dynamic QOS profile signaling details, according to an embodiment.

FIG. 2 illustrates a flow diagram of a method for dynamic QoS profile signaling details performed by a STA, according to an embodiment.

FIG. 3 illustrates a flow diagram of a method for dynamic QoS profile signaling details performed by an AP, according to an embodiment.

FIG. 4A illustrates an SCS request and SCS response exchange, according to an embodiment.

FIG. 4B illustrates a STA providing a dynamic QoS profile switch or update indication to an AP, according to an embodiment.

FIG. 4C illustrates an SCS descriptor element including one or more QoS characteristics elements that are included in an SCS request, according to an embodiment.

FIG. 4D illustrates a QoS characteristics element that is enhanced to include a QoS profile info field and a current profile indication, according to an embodiment.

FIG. 4E illustrates an SCS descriptor element including a QoS profile status subelement that is included an SCS response frame, according to an embodiment.

FIG. 4F illustrates a QoS characteristics element including a maximum data rate field, according to an embodiment.

FIG. 4G illustrates a STA signaling a Maximum Data Rate field in the QoS characteristics element that is included in an SCS request, according to an embodiment.

FIG. 4H illustrates a STA signaling a QoS profile for an UL SCS flow that requests more triggers, according to an embodiment.

FIG. 4I illustrates a control field that includes an SCSID and a QoS Profile ID signaled for activation of a QoS profile of an SCS flow, according to an embodiment.

FIG. 5 illustrates multiple QoS profiles with each QoS profile providing QoS parameters for specific QoS modes, according to an embodiment.

FIG. 6 illustrates an AP allocating UL resources to a STA based on a QoS profile switch, according to an embodiment.

FIG. 7 illustrates indicating a switch to a new QoS profile, according to an embodiment.

FIG. 8 illustrates a computer system, according to an embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure relates to a wireless device including one or more memories and one or more processors communicatively coupled to the one or more memories, where the one or more processors are configured to, individually or collectively, perform operations including identifying a flow, the SCS flow associated with an SCS identifier, and transmitting an SCS request to an access point (AP), the SCS request comprising information for a plurality of quality of service (QoS) profiles associated with the SCS identifier, each of the plurality of QoS profiles defining a different set of QoS characteristics.

In one embodiment, the information for the plurality of QoS profiles includes a QoS profile identifier for each QoS profile and an indication of a currently active QoS profile.

In one embodiment, the flow includes an uplink (UL) SCS flow or a downlink (DL) SCS flow.

In one embodiment, the plurality of QoS profiles include a QoS profile that indicates a request to terminate UL triggering for the flow.

In one embodiment, the operations further include aggregating QoS requirements across a set of one or more traffic flows in the plurality of QoS profiles.

In one embodiment, the operations further include receiving an SCS response from the AP accepting at least a subset of the plurality of QoS profiles for the flow or indicating that none of the QoS profiles are accepted for the flow.

In one embodiment, the SCS request further includes traffic classification (TCLAS) information for identifying the flow.

In one embodiment, each QoS profile corresponds to a different set of QoS parameters, and where the different set of QoS parameters are provided in a separate QoS characteristics element for each QoS profile.

In one embodiment, the SCS request further includes a request for additional resources from the AP up to a maximum data rate limit for one or more QoS profiles in the plurality of QoS profiles.

In one embodiment, the operations further include indicating a switch to a new QoS profile among the plurality of QoS profiles via an initial control frame (ICF) or an initial control response (ICR) frame.

One embodiment, presented in this disclosure relates to a network device including one or more memories and one or more processors communicatively coupled to the one or more memories, where the one or more processors are configured to, individually or collectively, perform operations including receiving a stream classification service (SCS) request from a station (STA), the SCS request including information for a plurality of quality of service (QoS) profiles associated with an SCS identifier of a flow, each of the plurality of QoS profiles defining a different set of QoS characteristics and transmitting, to the STA, an SCS response.

In one embodiment, the SCS response includes an indication that at least a subset of the plurality of QoS profiles are accepted for the flow or that none of the QoS profiles are accepted for the flow.

In one embodiment, the information for the plurality of QoS profiles includes a QoS profile identifier for each QoS profile and an indication of a currently active QoS profile.

In one embodiment, the flow includes a UL SCS flow or a DL SCS flow.

In one embodiment, the plurality of QoS profiles include a QoS profile requesting termination of UL triggering for the flow.

In one embodiment, the operations further include accepting a currently active QoS profile among the plurality of QoS profiles and allocating resources to the flow based on the currently active QoS profile.

In one embodiment, the SCS request further includes a request for additional resources from the network device up to a maximum data rate limit for one or more QoS profiles in the plurality of QoS profiles.

In one embodiment, the operations further include receiving, from the STA, an initial control frame (ICF) or an initial control response (ICR) frame indicating a switch to a new QoS profile among the plurality of QoS profiles associated with the SCS identifier.

In one embodiment, the operations further include the network device allocating resources to the flow based on the new QoS profile.

In one embodiment, the operations further include terminating UL triggering for the flow if the new QoS profile indicates a request to terminate UL triggering for the flow.

### Example Embodiments

Embodiments describe dynamic QoS profile signaling details. UL triggering allows an AP to perform intelligent scheduling to meet traffic QoS requirements. However, STAs may inadvertently disable UL MU data when they have not been triggered for an extended period and have been left in an idle state.

For UL flows, if the STA's QoS requirements change dynamically, it may be desired for the STA to request a change to its UL triggering schedule by the AP to meet its updated QoS requirements and prevent the STA from reverting to contention based EDCA operations or from disabling UL MU data after insufficient UL triggering. Similarly, for DL flows, the STA's QoS requirements may change dynamically, and the STA may indicate its changed QoS requirements to the AP. Therefore, in embodiments, the STA and AP may negotiate and support signaling dynamic changes to QoS requirements for SCS flows to meet updated QoS requirements for UL, DL, or some combination thereof.

Using an aggregate control (A-control) field, for example, a STA can dynamically indicate a different QoS profile to be used for an SCS flow or application so that the QoS profile can be switched when QoS requirements change. There are applications such as video collaboration, robotics/industrial internet of things (IoT), and real-time gaming where QoS requirements can dynamically change at run time. For example, in a video collaboration application, a session may start with a 4K codec, change to a 1K codec due to poor network conditions, and then revert to 4K at a later point in time. For IOT, higher latency can occur periodically when a robotic arm is doing a more precise task. For these applications, the AP can be notified of dynamic changes to QoS requirements so that it can better meet QoS requirements across different applications in its UL and DL scheduling. For example, a STA can provide multiple QoS profiles, each associated with a different set of QoS requirements, which the STA can dynamically switch between and change the currently active QoS profile.

A STA may aggregate UL triggering requirements across multiple flows and send a single SCS request indicating parameters for UL triggering (e.g., min/max service interval, min data rate, etc.) without providing UL traffic classification (TCLAS) information identifying specific flows. Therefore, it may be advantageous for a STA to define and setup one or more QoS profiles for UL triggering with the AP.

In embodiments, the UL triggering may be independent of a specific application flow and enable a STA to dynamically signal to the AP that more frequent or less frequent triggering is needed to meet UL traffic demands by switching between profiles. In one embodiment, a STA may prefer to provide UL triggering requirements specifically for an SCS flow, where the STA may include the TCLAS information to identify the flow and provide one or more QoS profiles for UL triggering to the AP for the SCS flow. The STA may send an SCS request to the AP to setup a SCS flow/stream that indicates one or more QoS profiles for UL triggering. In one embodiment, the SCS flow/stream setup by a STA for UL may aggregate requirements for multiple UL traffic flows.

In one embodiment, one of the QoS profiles for UL may indicate that no UL triggering is needed for the SCS flow, thereby requesting the AP to pause triggering for the SCS flow. If the SCS flow indicates aggregation of QoS requirements across multiple or all UL flows, then activating a QoS profile that indicates no UL triggering may terminate UL triggering from the AP. A STA may decide to activate such a profile if the STA does not need any triggering from the AP or if the STA prefers to perform EDCA operations for UL data delivery instead of being triggered. As one example, the indication of no UL triggering in a QoS profile may comprise setting the Minimum Service Interval and the Maximum Service Interval fields to zero in the QoS characteristics element for the QoS profile. Alternatively, the STA may indicate using an explicit field (e.g. a ‘Stop UL Triggering’ field in a QoS Profile Info field) in the QoS profile to pause UL triggering when the profile becomes activated. If the STA activates a QoS profile that pauses or stops UL triggering for an SCS flow, then the STA may later switch to another QoS profile that resumes the UL triggering based on QoS parameters of the QoS profile.

Similarly, for DL, QoS requirements may dynamically change (e.g. minimum data rate, delay bound etc.) for a DL SCS flow. In embodiments, a STA may advantageously setup one or more QoS profiles to provide different QoS requirements to the AP for a DL SCS flow. The STA may send an SCS request to the AP to setup one or more QoS profiles for a DL SCS flow, where the request includes TCLAS information (e.g., TCLAS elements, TCLAS processing element, or some combination thereof) to identify the DL SCS flow.

Embodiments provide signaling enhancements to SCS for supporting dynamic QoS Profiles and signaling for UL and DL. A STA can signal multiple QoS Profiles in an SCS request. In embodiments, multiple QoS profiles may be associated with the same SCS identifier (ID). For each QoS profile, the STA may signal QoS parameters in a separate QoS Characteristics element. Each QoS profile may be identified by a QoS profile ID. The AP can decide to accept all or a subset of QoS profiles indicated or accept none of the QoS profiles (e.g. when there are not enough resources available or when there is a policy conflict). In one embodiment, the STA indicates which QoS Profile is currently active in the SCS Request. Later, the STA can dynamically signal to activate a different QoS profile.

In one embodiment, a QoS Characteristics element can be enhanced with a ‘QoS Profile Info’ field. The AP can accept/reject QoS profiles indicated for the SCS stream/flow based on its resource availability, policy, or some combination thereof. In one embodiment, the STA can signal a dynamic QoS profile change using a Control field in an A-Control sent in-band in an UL data MPDU or in a QoS null frame. In one embodiment, the switch between different QoS profiles can be indicated using an initial control frame (ICF), such as a buffer status report poll (BSRP) trigger frame. In one embodiment, the switch can be indicated using an initial control response (ICR) frame, such as a multi-station block acknowledgement (multi-STA BA) frame. Thus, a dynamic switch to a different QoS profile can be indicated by a STA using one or more of the described mechanisms.

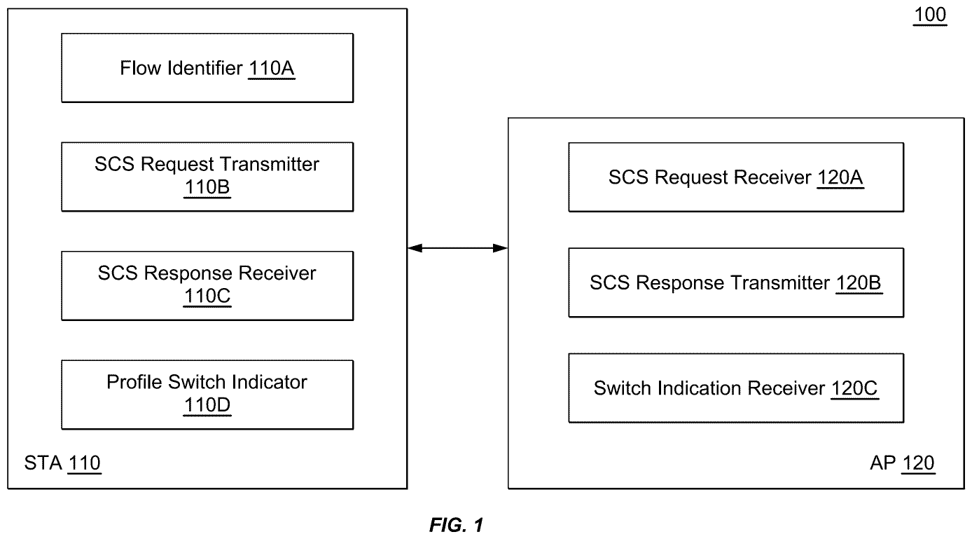

FIG. 1 illustrates a system for dynamic QoS profile signaling details, according to an embodiment. The system 100 involves communications between a STA 110 and an AP 120. The STA 110 may be a wireless device of a user. The AP 120 is a network device that connects wireless devices (e.g., non-AP STAs 110) to a network, such as to a local area network or the internet. The STA 110 and AP 120 may exchange messages over Wi-Fi or other IEEE 802.11 wireless medium. Network traffic between the STA 110 and AP 120 can be made more efficient using QoS and SCS mechanisms. In one embodiment, the STA 110 may be a non-AP MLD, and the AP 120 may be an AP MLD.

The STA 110 comprises a flow identifier 110A, SCS request transmitter 110B, SCS response receiver 110C, and profile switch indicator 110D. The flow identifier 110A identifies an SCS flow or an SCS stream. For example, the flow identifier 110A may determine the SCSID associated with an SCS flow where multiple QoS profiles will be negotiated. In one example, a STA 110 may use an application with dynamically changing QoS requirements, and switching between different QoS profiles at run time may be beneficial. In one embodiment, the STA 110 may associate the same SCSID with multiple traffic flows (e.g. in UL), which may advantageously aggregate QoS requirements for several different traffic flows. For example, the SCSID may identify an SCS flow/stream used to provide aggregate QoS requirements for multiple traffic flows. For example, by associating an SCSID with a plurality of traffic flows, the STA 110 can aggregate requests for more/less frequent triggering as a single SCS stream across multiple flows.

Additionally, the flow identifier 110A may determine the SCSID for an individual traffic flow (e.g. a flow identified using a TCLAS information) for either DL or UL. In DL, an SCSID may identify an individual traffic flow for which one or more QoS profiles is being provided by the STA 110 to the AP 120. In UL, an SCSID may identify an aggregate set of UL traffic flows for which aggregated QoS requirements are being provided in one or more QoS profiles, or an SCSID may identify an individual UL traffic flow for which QoS requirements are being provided in one or more QoS profiles. In one embodiment, for a DL SCS flow, QoS requirements may be provided across multiple DL traffic flows in one or more QoS profiles.

The SCS request transmitter 110B transmits SCS requests to the AP 120. In embodiments, an SCS request may include information for multiple QoS profiles that the STA may associate with the same SCSID. Each of the QoS profiles may define a different set of QoS characteristics. In one embodiment, each QoS profile may correspond to a different application. In one embodiment, each QoS profile may correspond to a different QoS mode of an application. For example, a video conferencing application may dynamically adjust encoding quality or bitrate during periods of higher and lower latency.

In the SCS request, a set of QoS characteristics elements may indicate the QoS profiles that the STA 110 wants to setup, establish, or otherwise make available for a given SCSID with the AP. Each QoS profile may be identified in the SCS request by a QoS profile ID, which may be provided as part of the QoS characteristics elements, e.g., using a ‘QoS Profile ID’ field included in the QoS characteristics element. In one embodiment, the QoS parameters for each QoS profile may be signaled by the STA 110 in a separate QoS characteristics element. Furthermore, the SCS request may include a field for signaling to the AP 120 which profile should be currently active. For example, the currently active QoS profile may be indicated using a ‘Current Profile’ field which may be set for one of the included QoS profiles. Once accepted by the AP 120, the AP 120 may allocate UL and DL resources to the STA based on the active QoS profile indicated in the SCS request.

In one embodiment, the SCS request may further indicate a request for additional resource allocation by the AP 120 up to a maximum data rate limit for the QoS profile, such as when the resource allocation may be needed by the STA to transmit its buffered UL traffic. For example, an additional ‘Maximum Data Rate’ field can be included in the QoS characteristics element that corresponds to a QoS profile. The Maximum Data Rate field may indicate that the STA 110 requests additional resource allocation by the AP 120 to the STA 110 up to the Maximum Data Rate limit for the QoS profile. For example, the additional resource allocation may be requested when the STA 110 has additional buffered UL traffic after the AP 120 has triggered the STA 110, in accordance with the QoS requirements of the QoS profile. As one example, the Maximum Data Rate field may be provided along with a QoS Profile Info field, where the QoS profile info may indicate an explicit request for allocating more resources (e.g. using an ‘Allocate More Resources’ field). As another example, the behavior of allocating more resources by the AP 120 may be implied or implicit if the Maximum Data Rate field is included.

In one embodiment, the Maximum Data Rate field may be included for all or a subset of QoS profiles provided in the SCS request. For example, for some QoS profiles the data rate may not greatly vary, and there may not be a need to include a Maximum Data Rate field. For other QoS profiles, data rates may vary, and therefore, it may be advantageous to include a Maximum Data Rate field.

In one embodiment, in the SCS request, the Maximum Data Rate field can be provided even when STA 110 is not creating one or more QoS profiles for an SCS flow. As an example, the STA 100 may provide a QoS characteristic element for an SCS flow to indicate QoS parameters for the SCS flow, rather than for creating one or more QoS profiles with the AP 120 for the SCS flow. The STA 110 may include the Maximum Data Rate field in the QoS characteristics element for the SCS flow to indicate to the AP 120 the STA's request for allocating additional resources for the SCS flow up to the Maximum Data Rate limit when needed. The Maximum Data Rate field may be provided by the STA 110 for an UL flow to request additional triggering from the AP 120. However, the Maximum Data Rate field may also be indicated for a DL flow to account for traffic data rate variations for DL flow, and the AP 120 may allow resource allocation for DL flows in its DL scheduling based on the Maximum Data Rate limit. For example, the AP's behavior of allocating more resources for UL or DL SCS flow (e.g., when needed) can be implied or implicit based on the inclusion of the Maximum Data Rate field. As one example, an explicit indication can be added to the SCS request to indicate a request for additional resource allocations based on the Maximum Data Rate limit. If the AP 120 accepts the SCS request that includes the Maximum Data Rate field for an SCS flow, then the limit may be considered by the AP 120 when needed.

The SCS response receiver 110C receives SCS responses from the AP 120. The SCS response may indicate which QoS profiles in the SCS request were accepted by the AP 120. For example, based on the resources available, needs of the STAs being served by the AP 120, and policies set for the network, the AP 120 may determine a subset of the QoS profiles that are acceptable. In one example, the AP 120 may determine that none of the profiles can be accepted, and the AP 120 may send an SCS response that indicates a failure status for the SCS flow (e.g., no QoS profiles are established, setup, or otherwise made available for the SCS flow).

The profile switch indicator 110D indicates a switch between QoS profiles to the AP. The switch may be communicated in a number of ways, depending on context. In one embodiment, the switch may be indicated in an SCS request (e.g., using a Request type set to ‘Change’) by activating a new QoS profile. In some embodiments, switches can be indicated in other UL communications for faster signaling. In one embodiment, the switch may be signaled using a Control field sent in an A-control. In one embodiment, the switch may be signaled using a Control frame, such as using an ICF or ICR frame.

The AP 120 comprises an SCS request receiver 120A, an SCS response transmitter 120B, and a switch indication receiver 120C. The SCS request receiver 120A receives SCS requests from the STA, including information for multiple QoS profiles associated with the same SCSID. The information for the QoS profiles may include QoS profile identifiers for each profile and an indication of a currently active QoS profile for the stream. QoS parameters for each QoS profile may be indicated in a separate QoS characteristics element. In one embodiment, the SCS request received may include a ‘Maximum Data Rate’ field as described above to indicate a request for allocating additional resources to the STA 110 up to a Maximum Data Rate limit for the QoS profile. In one embodiment, the SCS request may indicate a Maximum Data Rate limit even when the STA 110 may not be creating one or more QoS profiles, by including the Maximum Data Rate field in a QoS characteristics element included for the SCS flow.

The SCS response transmitter 120B transmits an SCS response to the STA. The SCS response may include a status for each QoS profile from the SCS request. For example, the AP may accept a subset of the QoS profiles and reject others due to insufficient resources or policy reasons. If the AP 120 accepts the QoS profile that is indicated as the currently active profile in the SCS request, the AP 120 may allocate resources for the STA for the SCS flow based on that currently active QoS profile. In one embodiment, the resources for the QoS profile may be allocated up to a maximum data rate field indicated for that QoS profile in the SCS request.

In one embodiment, the AP 120 may not accept the QoS profile that is indicated as currently active but may accept one or more other QoS profiles instead. The AP 120 may allocate resources based on the accepted QoS profile which may be closest to the QoS profile that was indicated as currently active in the SCS request. The AP 120 may indicate, in the SCS response, the accepted QoS profile for which the AP 120 is allocating resources, such as by including a QoS characteristics element in the SCS response that indicates the QoS profile or by indicating the QoS Profile ID for the QoS profile.

In one embodiment, if the QoS profile indicated as currently active is not accepted by the AP 120, then the AP 120 may reject the SCS request by indicating a failure status for the entire SCS flow or by indicating a rejection for every QoS profile. In one embodiment, the AP 120 may determine that none of the QoS profiles can be accepted, and the AP 120 may send an SCS response that indicates a failure status for the entire SCS flow or may indicate a rejection for every requested QoS profile.

The switch indication receiver 120C receives an indication of a switch between QoS profiles from the STA 110. For example, the indication may be received as part of a Control field in an A-Control or as part of control frame (e.g. in an ICF or an ICR control frame). The switch indication may comprise an SCSID and QoS Profile ID pair, thereby identifying the QoS profile that that STA 110 requests a switch to for the identified SCS stream/flow.

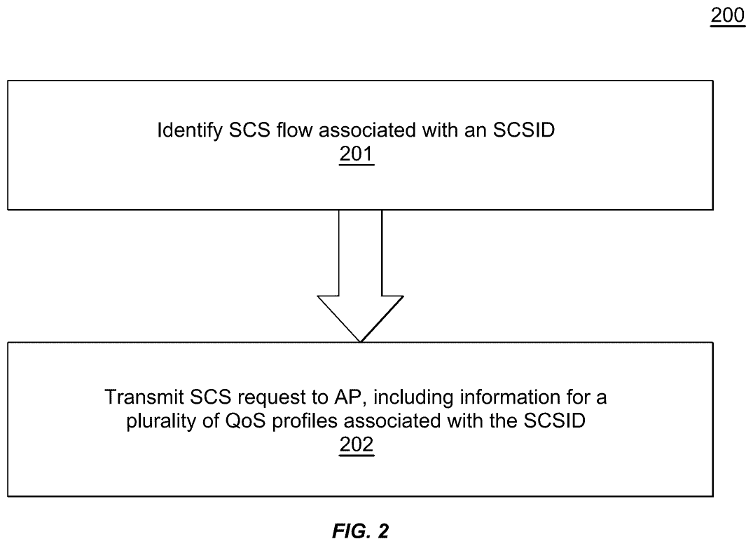

FIG. 2 illustrates a flow diagram of a method for dynamic QoS profile signaling details performed by a STA, according to an embodiment. In the method 200, at block 201, the STA identifies a flow associated with an SCSID. At block 202, the STA transmits an SCS request to an AP. The SCS request includes information for multiple QoS profiles associated with the SCSID.

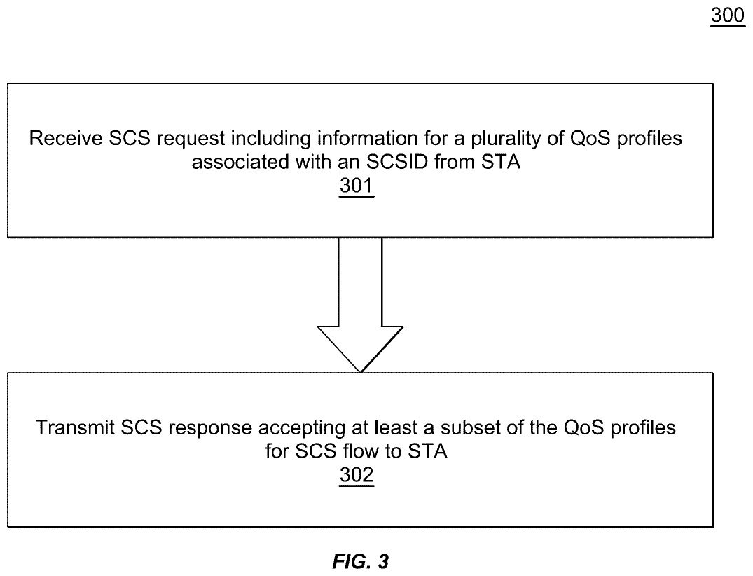

FIG. 3 illustrates a flow diagram of a method for dynamic QoS profile signaling details performed by an AP, according to an embodiment. In the method 300, at block 301, the AP receives an SCS request including information for a plurality of QoS profiles associated with an SCSID from a STA. At block 302, the AP transmits to the STA an SCS response accepting at least a subset of the QoS profiles for a flow.

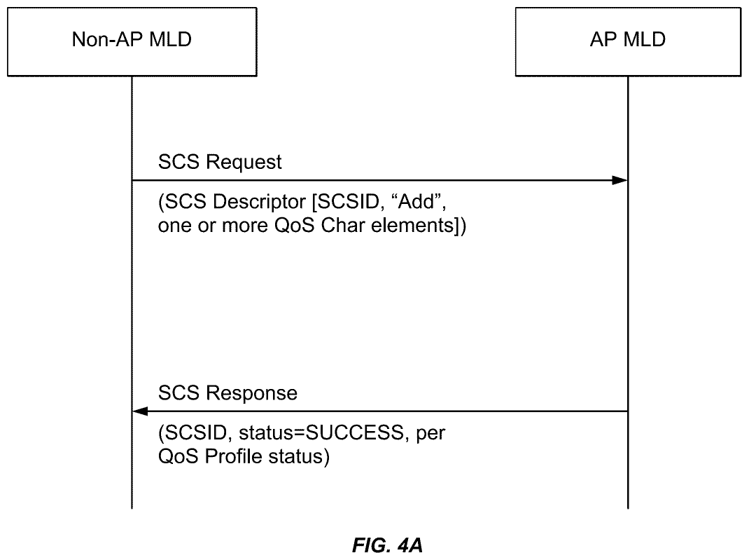

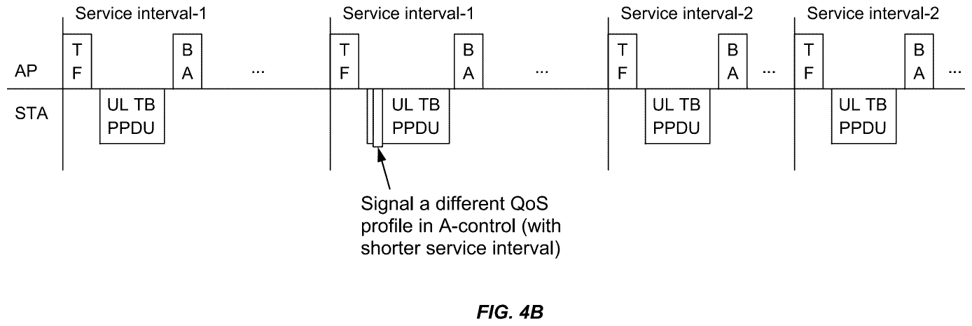

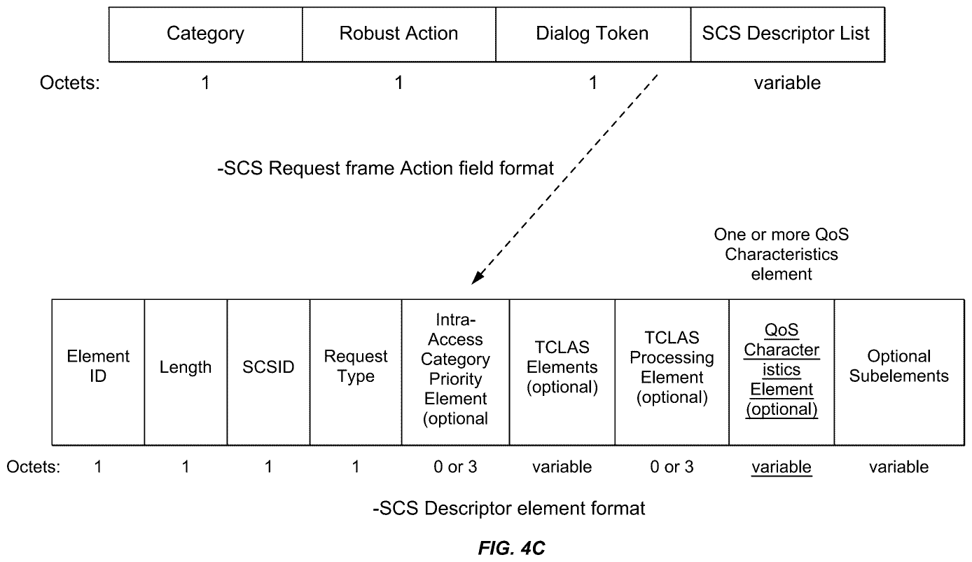

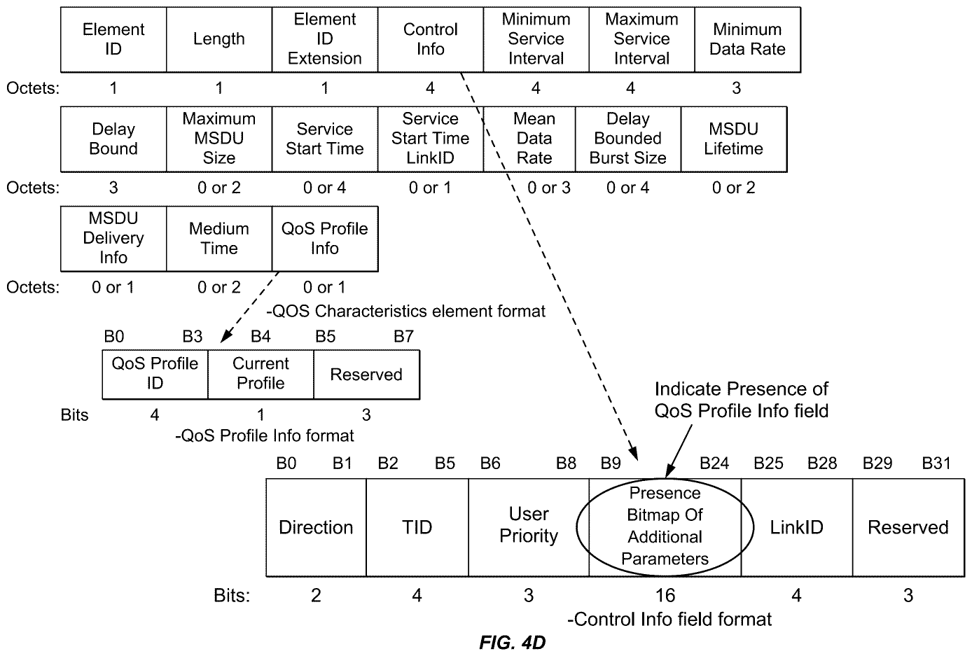

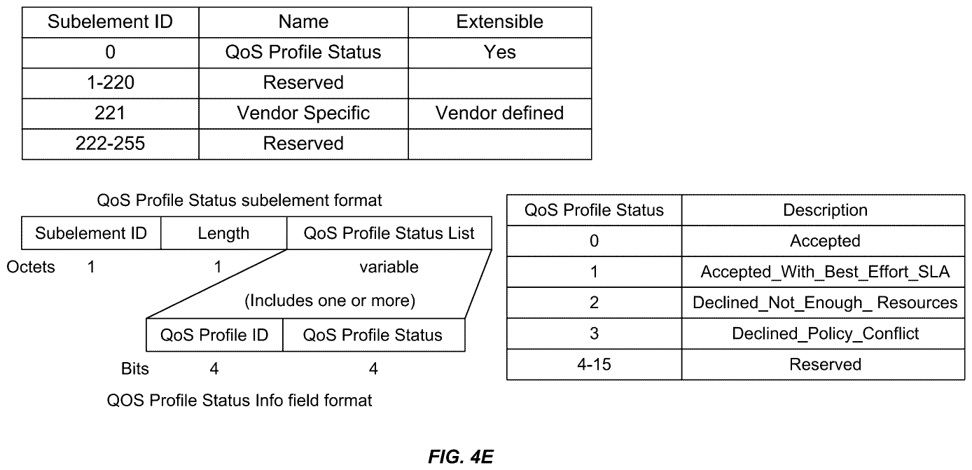

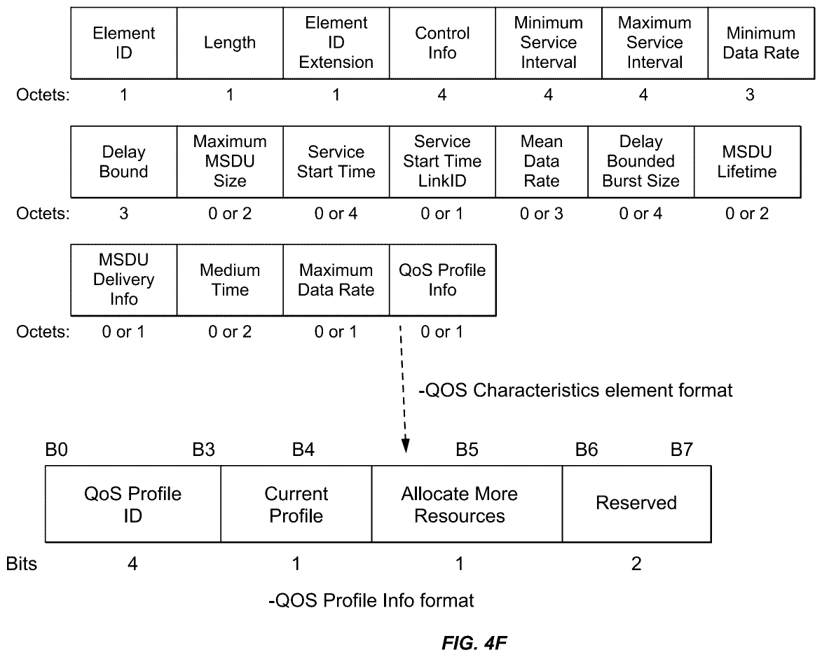

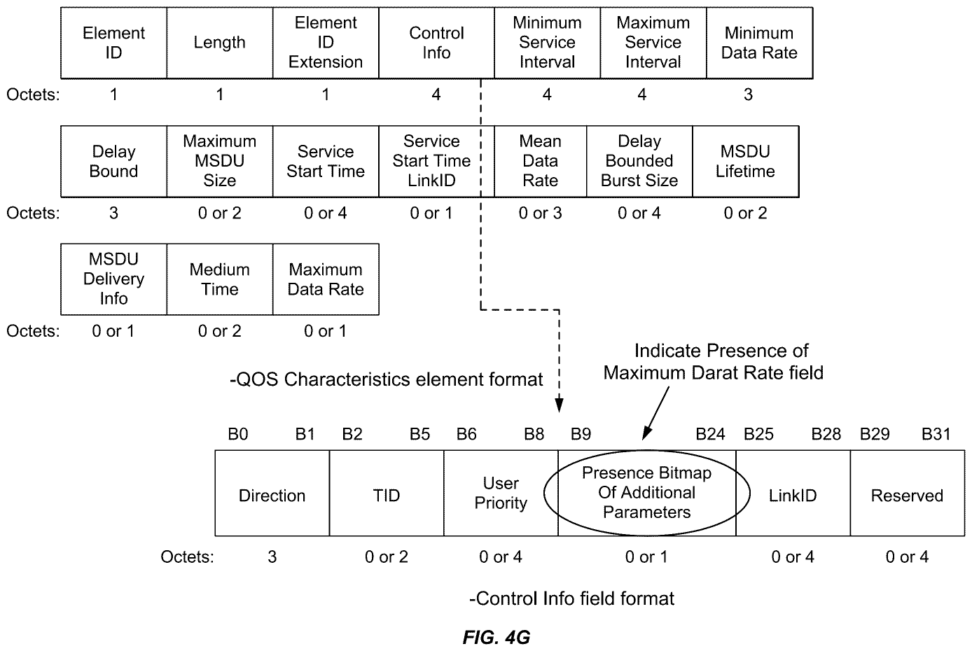

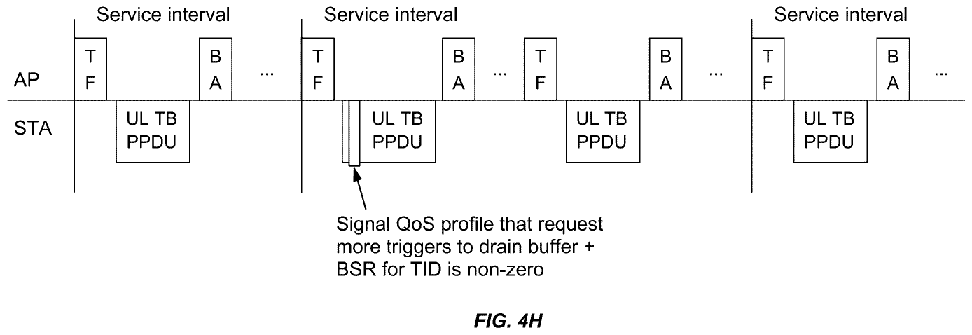

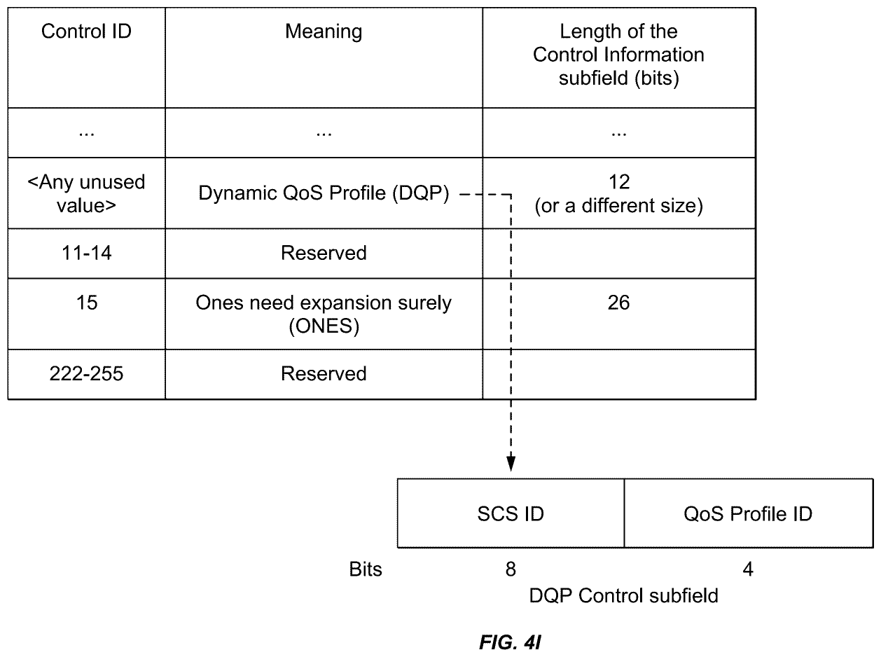

FIG. 4A illustrates an SCS request and SCS response exchange, according to an embodiment. The exchange may be used to setup multiple QoS profiles in association with an SCSID. Based on an active QoS profile, an AP, which may be an AP multi-link device (MLD), allocates UL and DL resources to a STA, which may be a non-AP MLD. In embodiments, a STA can send multiple QoS profiles for UL, DL, or some combination thereof. An SCS request sent by the STA to the AP may comprise an SCS descriptor element that includes the SCSID and a Request Type indication set to “Add,” by including one or more QoS characteristics elements. Each QoS profile may be identified by a QoS profile ID. In one embodiment, for each QoS profile, QoS parameters are signaled in a separate QoS characteristic element.

In an SCS response, the AP can accept or reject the QoS profiles identified based on resource availability, policy, or some combination thereof. The AP may send to the STA the SCS response, which may include the SCSID, QoS profile IDs, and statuses (e.g., accepted, best effort, rejected due to lack of resources, or rejected due to policy). In one embodiment, the exchange between a STA and AP may similarly be used to indicate a QoS profile that is requested for current activation. In the SCS Request, the STA may indicate the QoS profile currently requested for activation. In the SCS response, the AP indicates the status of the QoS profile, and if the QoS profile requested for activation is accepted by the AP, then the AP may activate the QoS profile and allocate resources based on the QoS profile.

FIG. 4B illustrates a STA providing a dynamic QoS profile switch or update indication to an AP, according to an embodiment. The indication may be provided to the AP after the STA has setup multiple QoS profiles with the AP for the SCS flow (e.g., using the SCS request/response exchange as described above, and where at least two QoS profiles are accepted by the AP for the SCS flow). Then, later when the QoS requirements dynamically change, the STA may provide a dynamic QoS profile update to the AP for an UL SCS flow using A-control in an UL data physical layer protocol data unit (PPDU) or in a UL QoS null frame. In the example shown, the updated QoS Profile for UL SCS flow indicates more frequent triggering at a shorter service interval-2, and the AP starts performing UL triggering with shorter service intervals thereafter, as shown by the more frequent trigger frames (TFs) sent by the AP.

FIG. 4C illustrates an SCS descriptor element including one or more QoS characteristics elements that are included in an SCS request, according to an embodiment. In the SCS request, the SCS Descriptor List field may include one or more SCS descriptor elements to setup a SCS flow/stream for one or more UL flows, DL flows, or some combination thereof. For setting up multiple QoS profiles for an SCS flow, the SCS request may include multiple QoS characteristics elements in the SCS descriptor for an SCSID, as shown. In embodiments, each QoS characteristics element may correspond to a different QoS profile for the SCSID. In the QoS characteristics element, a new QoS profile info field may be added to indicate QoS profile information.

FIG. 4D illustrates a QoS characteristics element that is enhanced to include a QoS profile info field and a current profile indication, according to an embodiment. The ‘QoS Profile Info’ field may indicate a QoS profile ID which uniquely identifies one of multiple QoS profiles for an SCSID. A ‘Current Profile’ field in the QoS Profile Info may identify the QoS profile which is indicated to be the currently active QoS profile. In one embodiment, the presence of the ‘QoS Profile Info’ field can be indicated using a bit in a ‘Presence Bitmap Of Additional Parameters’ subfield in the Control Info field of the QoS characteristics element.

FIG. 4E illustrates an SCS descriptor element including a QoS profile status subelement that is included an SCS response frame, according to an embodiment. The SCS response enhancements shown may apply to both UL and DL SCS flows. The SCS response frame format (as shown by the chart at the top of FIG. 4E), includes fields/subfields for subelement IDs, name of the subelement, and whether the subelement is extensible. The SCS descriptor element (as shown by the chart on the bottom right of FIG. 4E) in the SCS response may include a ‘QoS Profile Status’ subelement included as part of the Optional Subelements field that provides an accept/reject status for each QoS profile that was requested in the corresponding SCS request. In one embodiment, if at least one QoS profile is accepted by the AP, the overall SCSID Status in the SCS Status duple field in the SCS Status List field for that SCSID may be set to SUCCESS. In one embodiment, an accepted with best effort service level agreement status, e.g. ‘Accepted_With_Best_Effort_SLA’, may be indicated as an overall status for the SCSID when the AP does not currently have enough resources for the one or more QoS profiles but may attempt to meet the QoS profiles requirements as a Best Effort.

The QoS Profile Status subelement includes status information for QoS Profile that were requested in the corresponding SCS request. It includes a ‘QoS Profile Status Info List’ field that includes one or more ‘QoS Profile Status Info’ fields that provide an accept/reject status for each QoS profile ID. One QoS Profile Status Info field is included for each QoS profile that was requested in the corresponding SCS request to provide accept/reject status (provided in the QoS Profile Status field) for a QoS profile identified by the QoS Profile ID. In embodiments, the QoS profile statuses indicated in the QoS Profile Status field may include accepted, accepted with best effort SLA, declined due to not enough resources, declined due to policy conflict, other QoS profile statuses, or some combination thereof. In one embodiment, the QoS Profile Status field may be defined to be 1 octet, and then the QoS Profile Status Info field may be 2 octets long, with four reserved bits, four bits for QoS profile ID, and 8 bits for QoS profile status.

In one embodiment, the information provided in the ‘QoS Profile Status’ subelement may be provided in a separate element in the SCS descriptor element (e.g., instead of included as a subelement), such as by including a QoS Profile Status element (not shown) after the QoS characteristics element in the SCS descriptor element in the SCS response. In one embodiment, the ‘Optional Subelements’ field in the SCS descriptor element may not include a ‘QoS Profile Status’ subelement.

FIG. 4F illustrates a QoS characteristics element including a maximum data rate field, according to an embodiment. The enhancements shown provide throughput variability within a QoS profile for an UL SCS flow but may also be useful for DL SCS flows. For some applications, due to variable bitrate (VBR) within a specific QoS quality level, throughput requirements may vary in UL and/or DL. For example, with a VBR video codec data rate for a 2K quality video may vary between 20-25 megabits per second (Mbps). In one embodiment, a maximum data rate field can be added in a QoS characteristics element for an AP to account for variability in the data rate requirements for UL or DL SCS flow.

In one embodiment, a STA may include a maximum data rate in a QoS profile to indicate throughput variability up to a max data rate. In one embodiment, the STA may explicitly request that the AP allocate more resources up to a maximum data rate e.g. using an ‘Allocate More Resources’ field included in the QoS Profile Info field. For an UL SCS flow, this may indicate that a STA is requesting to be triggered more for sending UL data in the same service interval (SI) up to the indicated maximum data rate if the buffer status report (BSR) indicated for the traffic identifier (TID) of the QoS characteristics element is non-zero. In one case, the additional triggers from the AP may happen in a subsequent SI as well. For a DL SCS flow, this may indicate that AP supports a DL data rate up to a maximum data rate within an indicated Delay Bound for the DL SCS flow. The AP can accept or reject the QoS Profile that indicates maximum data rate and accordingly indicate the status in the SCS response as previously mentioned. If the QoS profile with the maximum data rate included is accepted by the AP, the STA may dynamically signal and activate the QoS profile, such as using A-control.

As shown in FIG. 4F, the enhancements to the QoS Characteristics element include a ‘Maximum Data Rate’ field. The ‘QoS Profile Info’ field may be extended to indicate an ‘Allocate More Resources’ field to explicitly request the AP to allocate more resources up to the ‘Maximum Data Rate’. For UL, the AP behavior may include performing more UL triggering for the STA in the same Service Interval up to the ‘Maximum Data Rate’ if BSR for the corresponding TID in the QoS characteristics element is non-zero in the UL PPDU received in response to the initial trigger frame sent to the STA.

FIG. 4G illustrates a STA signaling a Maximum Data Rate field in the QoS characteristics element that is included in an SCS request, according to an embodiment. As shown, a Maximum Data Rate field may be included when no QoS profiles are being created for the indicated SCS flow, as described previously above. In this case, the STA is only providing one QoS characteristic element for an SCS flow (identified by an SCSID) to indicate QoS parameters for that SCS flow. The STA also includes a Maximum Data Rate field in the QoS characteristics element for the SCS flow to indicate to the AP its request for allocating additional resources for the SCS flow up to the Maximum Data Rate limit when needed. The presence of the Maximum Data Rate field is indicated using a presence bit in the Control Info field of the QoS characteristic element as shown below. If the AP accepts the SCS request for an SCS flow that includes a Maximum Data Rate field in the QoS characteristic element, then the AP may trigger the STA more in a given service interval (SI) if a non-zero BSR is reported for the TID indicated in the QoS characteristic element for that SCS flow.

FIG. 4H illustrates a STA signaling a QoS profile for an UL SCS flow that requests more triggers, according to an embodiment. For an UL SCS flow, if the STA's buffer for a TID is filling up, the STA may dynamically signal (e.g., in an A-control) the QoS profile that requests for more UL triggers (e.g., up to a max data rate) in the same service interval to drain the buffers.

In one embodiment, if multiple flows are mapped to the same TID and remaining medium access control (MAC) service data units (MSDUs) in the TID buffer are allocated to a flow without a high QoS requirement, then the STA may be configured to not signal the QoS profile for more triggers for the SCS flow, even though it has non-zero BSR for the TID indicated in the QoS characteristics element. In one embodiment, when the AP receives a dynamic QoS profile change, the AP may attempt to trigger the STA up to a maximum data rate in the same interval, in accordance with resource availability, may provide additional triggering to STAs in a subsequent SI, or some combination thereof. In one embodiment, when the STA no longer needs more UL triggering, the STA may dynamically change to a different QoS profile that does not ask for more triggering. As shown in FIG. 4G, the STA signals a QoS profile for an UL SCS flow that requests more triggers to drain a buffer, and the BSR for the TID may indicate a non-zero value. As a result, the AP may further trigger the STA in the same service interval, as shown by a second trigger frame sent to the STA in the middle service interval.

FIG. 4I illustrates a control field that includes an SCSID and a QoS Profile ID signaled for activation of a QoS profile of an SCS flow, according to an embodiment. The enhancements shown use A-control to signal a dynamic QoS profile and may apply to both UL and DL SCS flows. The in-band A-Control enhancements for supporting dynamic QoS profiles advantageously enable the AP to more accurately assess dynamically changing QoS for applications to better serve and meet QoS requirements for the applications and STAs in the basic service set (BSS).

In one embodiment, a dynamic QoS profile (DQP) control ID may be added in the high-efficiency (HE) A-Control to signal dynamic changes to the QoS profile. As shown in FIG. 4I, the definition for DQP Control field includes an SCSID and a QoS Profile ID of the SCS flow that is signaled to be activated in the DQP Control. In one embodiment, the fields for dynamically switching to a different QoS profile for an SCS flow (e.g. SCSID and QoS Profile ID) may be indicated as part of an existing control field or a new control field as defined by a DQP control field or other control field name.

In one embodiment, support for the dynamic QoS profile may be indicated in the UHR MAC capabilities by both the AP and the non-AP STA, in an ‘Extended Capabilities’ element, other capabilities related field, other element, or some combination thereof. In one embodiment, the STA and AP may perform an enhanced SCS request/response exchange to setup one or more QoS profiles if both peers have indicated support for the related capability. In one embodiment, the STA may send a dynamic QoS profile in the A-control if the AP has indicated support for receiving DQP control.

In one embodiment, a single capability indication may be used for signaling support for SCS request and SCS response enhancements for dynamic QoS profiles (e.g., support for setting up multiple QoS profiles) and support for DQP Control in the A-Control. In one embodiment, one capability indication is used for signaling support for SCS request and response enhancements for dynamic QoS profiles, and a separate capability indication may be used for indicating support for DQP Control in the A-Control.

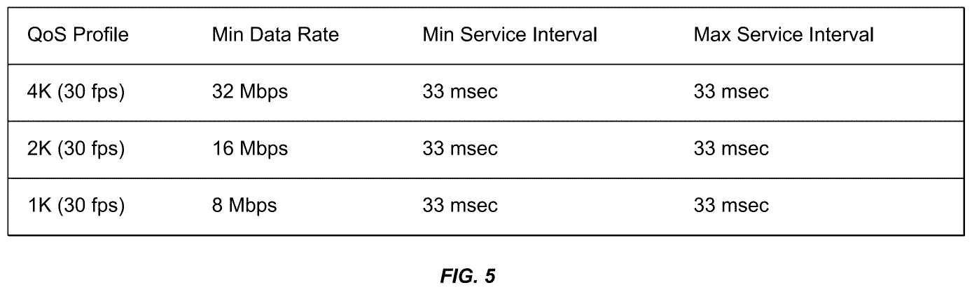

FIG. 5 illustrates multiple QoS profiles with each QoS profile providing QoS parameters for specific QoS modes, according to an embodiment. In one example, the QoS profiles may map to different codec modes for a video collaboration application. As mentioned above, applications such as video collaboration, robotics, IOT, and real-time gaming may have QoS requirements that dynamically and frequently change at run time. Typically, for such applications there is no mechanism defined for a STA to indicate a fast QoS requirement change to the AP without requiring another SCS renegotiation. Disadvantageously, a renegotiation may be disruptive to meeting dynamic changes to QoS requirements. It is desirable that the AP is notified of dynamic changes to QoS requirements of UL and DL flows so that it can better meet QoS requirements across different applications in its UL & DL scheduling.

If the AP is not notified of dynamic changes to QoS requirements, then the AP may disadvantageously under-reserve or over-reserve resources for the STA. If the AP under-reserves a STA, such as when the STA's QoS requirement for a video collaboration application has changed to 4K mode and the AP is still allocating resource units (RUs) for 1K, the application data rate requirement may not be met, and the quality may degrade. If the AP over reserves resources because STA is always asking for highest QoS, such as when a STA frequently asks for a 4K QoS requirement for a video application even though its QoS requirement switches between 4K, 2K, and 1K, the network resources may be wasted, thereby impacting QoS for other STAs and leading to poor overall network efficiency.

Advantageously, embodiments provide a mechanism where a STA can notify the AP about dynamic changes to the QoS requirement for an SCS stream using a fast method without requiring management level renegotiation. In one embodiment, to support dynamic QoS changes, a STA can request setting up multiple QoS Profiles in the SCS request for a given SCS stream. As shown in FIG. 5, each QoS profile may provide QoS parameters for a specific QoS mode, such as 4K, 2K, 1K which are associated with a ‘Min Data Rate’ of 32 Mbps, 16 Mbps, and 8 Mbps respectively.

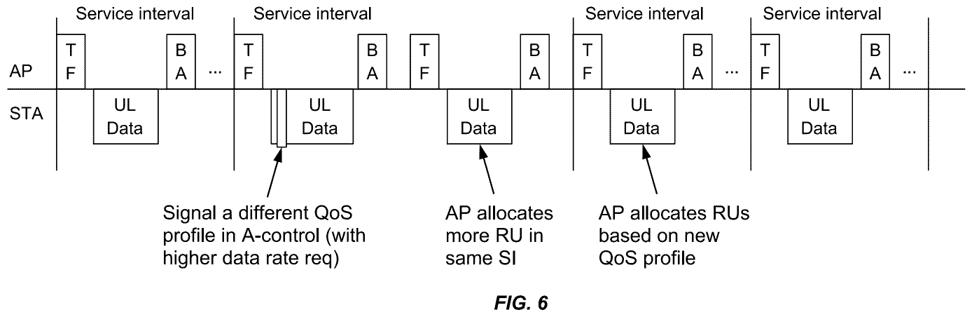

FIG. 6 illustrates an AP allocating UL resources to a STA based on a QoS profile switch, according to an embodiment. When QoS requirement changes dynamically for an application, the STA may signal a switch to a different QoS profile among the set of accepted QoS profiles for the SCS stream. In one embodiment, a QoS profile switch may be signalled using a control field in an A-Control for faster signalling. In one embodiment, a QoS profile switch can be signalled in a Control frame, e.g. using an ICF or an ICR control frame. In one embodiment, the QoS profile switch may be indicated using an SCSID and a QoS profile ID of a new QoS profile that is targeted. After the QoS Profile switch, the AP may allocate UL resources to the STA based on the new QoS profile.

In one embodiment, the AP may allocate more resources to the STA in the same SI by triggering the STA more frequently based on an updated QoS profile (e.g., with a ‘Maximum Data Rate’ field indicated in the updated QoS profile), as shown. Then, from subsequent Sis thereafter, the AP may allocate resources based on update QoS profile.

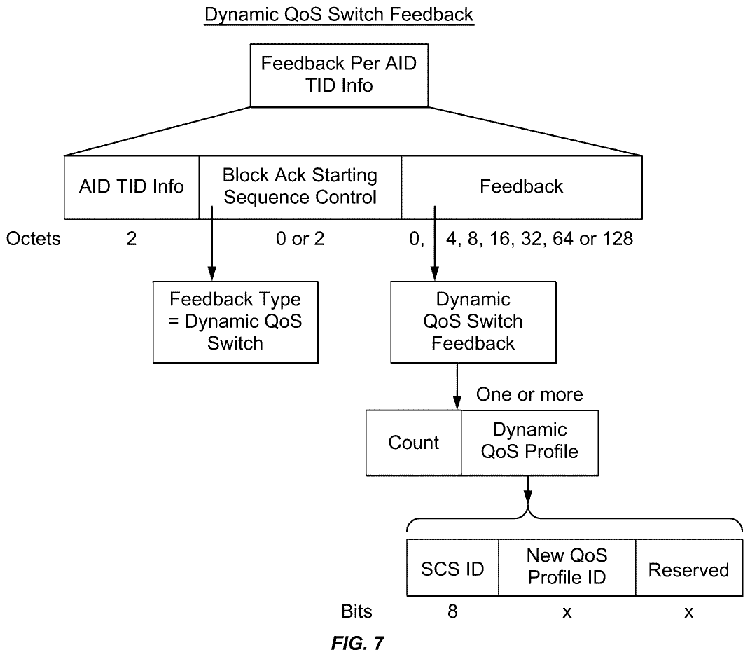

FIG. 7 illustrates indicating a switch to a new QoS profile, according to an embodiment. In one embodiment, after the STA has established multiple QoS profiles with the AP for an SCSID using an SCS request/response exchange, a non-AP STA can signal a dynamic switch between different QoS profiles that were accepted by the AP. For example, the STA can indicate a new QoS profile for the SCS stream in an initial control frame (ICF) or an initial control response (ICR) frame.

In one embodiment, the STA may indicate the switch to a new QoS profile for an SCS stream in an ICF, such as in a buffer status report poll (BSRP) trigger frame or a BSRP NTB (non-trigger based) trigger frame (as defined in 802.11bn amendment). The ICF (or BSRP trigger frame or BSRP NTB trigger frame) may initiated by the STA. The frame may include fields for the SCSID and a new QoS profile ID, indicating a new QoS profile that the STA switches to. The fields may be included in a new user info field in the ICF, which may be defined as a special user info field for providing information for dynamic QoS profile switching. For example, a new AID value can be assigned for the special User Info field or an AID value can be re-used for other reasons. More than one pair of <SCS ID, new QoS Profile ID> fields can be included in the ICF to indicate a switch to a new QoS Profile for multiple active SCS streams. A count field can be included to indicate the number of SCSIDs for which a switch to the new QoS Profile is indicated in the ICF. Alternatively, the non-AP STA may indicate a switch to the new QoS profile in the Common Info field of the BSRP Trigger frame.

In one embodiment, the STA may indicate a switch to a new QoS profile for an SCS stream in an ICR, such as in a Multi-STA block acknowledgement (BA) frame. In one embodiment, a ‘Dynamic QoS Switch’ Feedback type can be defined for the Feedback Per AID TID field (e.g., as defined in IEEE 802.11bn), which may be used to indicate the switch to the new QoS profile for an SCSID.

In one embodiment, the feedback type may include <SCS ID, New QoS Profile ID> fields, where the New QoS Profile ID may indicate the new QoS profile for the SCSID, as shown. The feedback may also indicate a dynamic QoS profile switch for more than one SCSID at the non-AP STA, by including multiple sets of <SCS ID, New QoS Profile ID> fields. In one embodiment, a new Per AID TID field can be defined for providing ‘Dynamic QoS Switch’ information and carried in the Multi-STA BA frame. In one embodiment, both ICF and ICR switch indication may be supported, and the STA may use either option to indicate the switch to a new QoS profile for an SCSID.

As shown in FIG. 7, an example format for ICR indication that indicates dynamic QoS profile switching in the multi-STA BA ICR frame is provided. The format uses the new feedback type for the feedback per association ID (Per AID) TID Info. When the QoS requirements for an application change dynamically, the AP may be notified so that the AP can perform efficient scheduling for resources in UL and DL to meet QoS requirements across all its flows. As such, embodiments advantageously enhance SCS mechanisms to enable a STA to signal multiple QoS profiles in an SCS request for an SCS stream. Thus, when a QoS requirement changes for the SCS flow/stream at run time, the STA may dynamically switch between different QoS profiles.

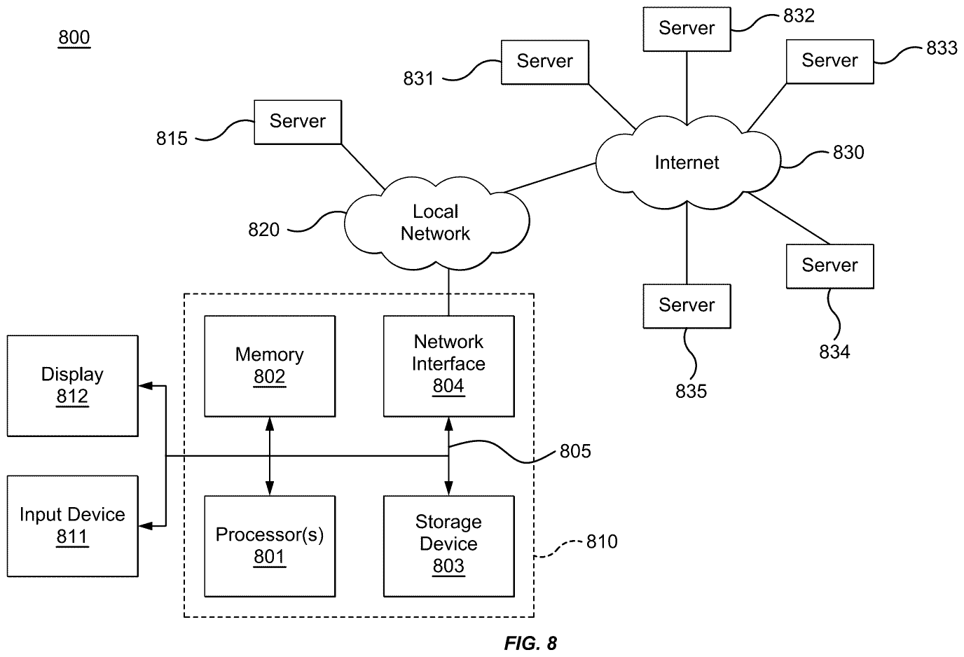

FIG. 8 illustrates a computer system, according to an embodiment. Computer system 810 includes a bus 805 or other communication mechanism for communicating information, and a processor 801 coupled with bus 805 for processing information. Computer system 810 also includes a memory 802 coupled to bus 805 for storing information and instructions to be executed by processor 801, including information and instructions for performing the techniques described above, for example. This memory may also be used for storing variables or other intermediate information during execution of instructions to be executed by processor 801. Possible implementations of this memory may be, but are not limited to, random access memory (RAM), read only memory (ROM), or both. A storage device 803 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 803 may include source code, binary code, or software files for performing the techniques above, for example. Storage device and memory are both examples of computer readable mediums.

Computer system 810 may be coupled via bus 805 to a display 812, such as a cathode ray tube (CRT) or liquid crystal display (LCD), for displaying information to a computer user. An input device 811 such as a keyboard and/or mouse is coupled to bus 805 for communicating information and command selections from the user to processor 801. The combination of these components allows the user to communicate with the system. In some systems, bus 805 may be divided into multiple specialized buses.

Computer system 810 also includes a network interface 804 coupled with bus 805. Network interface 804 may provide two-way data communication between computer system 810 and the local network 820. The network interface 804 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 804 sends and receives electrical, electromagnetic, or optical signals that carry digital data streams representing various types of information.

Computer system 810 can send and receive information, including messages or other interface actions, through the network interface 804 across a local network 820, an Intranet, or the Internet 830. For a local network, computer system 810 may communicate with a plurality of other computer machines, such as server 815. Accordingly, computer system 810 and server computer systems represented by server 815 may form a cloud computing network, which may be programmed with processes described herein. In the Internet example, software components or services may reside on multiple different computer systems 810 or servers 831-835 across the network.

The processes described above may be implemented on one or more servers, for example. A server 831 may transmit actions or messages from one component, through Internet 830, local network 820, and network interface 804 to a component on computer system 810. The software components and processes described above may be implemented on any computer system and send and/or receive information across a network, for example.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A wireless device comprising:
one or more memories; and
one or more processors communicatively coupled to the one or more memories, wherein the one or more processors are configured to, individually or collectively, perform operations comprising:
identifying a flow, the flow associated with a stream classification service (SCS) identifier; and
transmitting an SCS request to an access point (AP), the SCS request comprising information for a plurality of quality of service (QoS) profiles associated with the SCS identifier, each of the plurality of QoS profiles defining a different set of QoS characteristics.

2. The wireless device of claim 1, wherein the information for the plurality of QoS profiles comprises a QoS profile identifier for each QoS profile and an indication of a currently active QoS profile.

3. The wireless device of claim 1, wherein the flow comprises an uplink (UL) SCS flow or a downlink (DL) SCS flow.

4. The wireless device of claim 1, wherein the plurality of QoS profiles comprise a QoS profile that indicates a request to terminate UL triggering for the flow.

5. The wireless device of claim 1, wherein the operations further comprise:
aggregating QoS requirements across a set of one or more traffic flows in the plurality of QoS profiles.

6. The wireless device of claim 1, wherein the operations further comprise:
receiving an SCS response from the AP accepting at least a subset of the plurality of QoS profiles for the flow or indicating that no QoS profile from the plurality of QoS profiles are accepted for the flow.

7. The wireless device of claim 1, wherein the SCS request further comprises traffic classification (TCLAS) information for identifying the flow.

8. The wireless device of claim 1, wherein each QoS profile corresponds to a different set of QoS parameters, and wherein the different set of QoS parameters are provided in a separate QoS characteristics element for each QoS profile.

9. The wireless device of claim 1, wherein the SCS request further comprises a request for additional resources from the AP up to a maximum data rate limit for one or more QoS profiles in the plurality of QoS profiles.

10. The wireless device of claim 1, wherein the operations further comprise:
indicating a switch to a new QoS profile among the plurality of QoS profiles via an initial control frame (ICF) or an initial control response (ICR) frame.

11. A network device comprising:
one or more memories; and
one or more processors communicatively coupled to the one or more memories, wherein the one or more processors are configured to, individually or collectively, perform operations comprising:
receiving a stream classification service (SCS) request from a station (STA), the SCS request comprising information for a plurality of quality of service (QoS) profiles associated with an SCS identifier of a flow, each of the plurality of QoS profiles defining a different set of QoS characteristics; and
transmitting, to the STA, an SCS response.

12. The network device of claim 11, wherein the SCS response comprises an indication that at least a subset of the plurality of QoS profiles are accepted for the flow or that no QoS profile from the plurality of QoS profiles are accepted for the flow.

13. The network device of claim 11, wherein the information for the plurality of QoS profiles comprises a QoS profile identifier for each QoS profile and an indication of a currently active QoS profile.

14. The network device of claim 11, wherein the flow comprises a UL SCS flow or a DL SCS flow.

15. The network device of claim 11, wherein the plurality of QoS profiles comprise a QoS profile requesting termination of UL triggering for the flow.

16. The network device of claim 11, wherein the operations further comprise:
accepting a currently active QoS profile among the plurality of QoS profiles and allocating resources to the flow based on the currently active QoS profile.

17. The network device of claim 11, wherein the SCS request further comprises a request for additional resources from the network device up to a maximum data rate limit for one or more QoS profiles in the plurality of QoS profiles.

18. The network device of claim 11, wherein the operations further comprise:
receiving, from the STA, an initial control frame (ICF) or an initial control response (ICR) frame indicating a switch to a new QoS profile among the plurality of QoS profiles associated with the SCS identifier.

19. The network device of claim 18, wherein the operations further comprise the network device allocating resources to the flow based on the new QoS profile.

20. The network device of claim 18, wherein the operations further comprise terminating UL triggering for the flow if the new QoS profile indicates a request to terminate UL triggering for the flow.
